(19) United States
(12) Patent Application Publication
(10) Pub. No.: US 2006/0077890 A1
(43) Pub. Date: Apr. 13, 2006

(54) Efficient source blocking algorithm for FEC for MBMS streaming

(75) Inventors: Vijay Suryavanshi, Richardson, TX (US); Ramakrishna Vedantham, Irving, TX (US); Igor Curcio, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/244,629

(22) Filed: Oct. 5, 2005

Related U.S. Application Data
(60) Provisional application No. 60/617,413, filed on Oct. 7, 2004.
(60) Provisional application No. 60/617,003, filed on Oct. 8, 2004.
(60) Provisional application No. 60/628,095, filed on Nov. 15, 2004.

(51) Int. Cl. H04J 1/16

(52) U.S. Cl. 370/216; 370/242; 714/2

(57) ABSTRACT

A hybrid-padding approach for arranging variable size data packets for error correction encoding and decoding is disclosed. The approach can involve arranging the data packets in columns and rows and selecting the row size to minimize the amount of padding required. If data packet is smaller than the number of rows the data packet is inserted into the column and the remaining rows are padded. If the data packet is larger than the number of rows, the data packet is allowed to span multiple columns with the last column being padded if necessary. The data packets can include parameters, such as a source block number, packet length, and starting column number, and the error correction packets can include parameters, such as, a source block number an N, a K, the starting column number, and the number of row, to signal the hybrid-padding message.

### FIELD OF THE INVENTION

The present invention relates generally to the field of error correction techniques and more specifically forward error correction techniques for use with Multimedia Broadcast Multicast Services (MBMS).

### BACKGROUND INFORMATION

When a transmitting end transmits media objects in the form of data packets to a receiving end, for instance via the Internet, some of the data packets may be lost on the way. It is therefore common practice to transmit in addition error correction data to the receiving end. The error correction data may enable the receiving end to restore lost data packets to a considerable extent.

For Multimedia Broadcast Multicast Services (MBMS) download services, for example, which distribute data packets via the Internet, a Forward Error Correction (FEC) at the application layer is used according to the RMT internet draft draft-ietf-rmt-flute-08.txt: “FLUTE—File Delivery over Unidirectional Transport”, Jun. 5, 2004. By using a simple source-blocking algorithm, the source data can be conveniently arranged into equal length packets and the packets can be FEC encoded to produce parity packets. The size of the packet can be conveniently chosen to satisfy the underlying network requirement.

The packetization, source-blocking and FEC encoding process which is employed for MBMS download services is illustrated in FIG. 1. For the FEC encoding process, K data packets 13 of equal size S are formed from available data. Data symbols at the same position in each data packet 13 are used for generating (N-K) FEC symbols or parity symbols. Dotted lines in FIG. 1 represent a respective single codeword 17 consisting of K data symbols and (N-K) parity symbols. The codeword 17 can be for example a systematic RS codeword. The ith parity symbols in each codeword, with i=0 to (N-K−1), then form a respective parity packet 16, which are transmitted together along with the data packets 13.

At the receiving end, lost data packets 13 can then be recovered, if any K (1+ε) packets 13, 16 out of a total of N packets are received. Here, ε is known as the reception overhead or decoding inefficiency. For Reed-Solomon (RS) Codes, ε is equal to zero. This scheme of packetization and source-blocking will be referred to in the following as a “packet-based approach”.

According to the technical document 3GPP S4-040549: “Requirements on FEC Architecture and Codes for MBMS Streaming”, an FEC at the application layer is to be used as well for MBMS streaming. A FEC architecture for MBMS streaming shall include the packetization, interleaving, source blocking, FEC encoding and FEC decoding, source deblocking procedures that meet these requirements.

For MBMS streaming services, however, the packet based approach described above for MBMS download services has severe disadvantages. For MBMS streaming services, the media objects are segmented into packets using the Realtime Transfer Protocol (RTP)/User Datagram Protocol (UDP)/Internet Protocol (IP), where the size of the RTP packets of the application layer is variable and highly media dependent. Padding symbols could be employed to obtain equal size data packets from variable size RTP packets, but this could result in a significant wastage of FEC overhead. Alternatively, the media-encoders, like H.264 encoders, could be requested to provide almost equal-size RTP packets, but MBMS streaming services shall support a wide range of source-encoders, which may not all output equal-length RTP packets. Moreover, MBMS streaming shall support pre-encoded media streams also. Hence, it is necessary to use an approach which supports the use of an FEC with variable size RTP packets instead of equal length packets.

There exist several IETF frameworks that facilitate the use of an application layer FEC for streaming, but which do not meet the requirements of an FEC architecture for MBMS streaming.

The frameworks presented in the IETF document RFC 2733: “An RTP Payload Format for Generic Forward Error Correction”, December 1999, and in the Internet Draft IETF I-D ULP draft-ietf-avt-ulp-10.txt: “An RTP Payload Format for Generic FEC”, Jul. 18, 2004, both have the drawback that they are applicable only to simple XOR based FEC codes, while there exist much more powerful FEC codes, like Reed-Solomon codes, Low Density Parity Check (LDPC) codes, Raptor codes, etc., that have moderate or at least manageable complexity. Moreover, in the case of the RFC 2733, the FEC can be used to protect at the most 24 data packets, and in the case of the ULP draft, the FEC can be used to protect at the most 48 data packets. Thus, the block length of the FEC is limited to 24 or 48 data packets, respectively. Reed-Solomon and LDPC codes, however, need larger block lengths that cannot be provided by the presented packetization frameworks. Moreover, both documents recommend the use of padding in order to deal with variable size RTP packets. If the variation in the RTP packet length is high, this results in a significant amount of FEC being used to protect padded bits. The ULP document moreover supports unequal error protection that may or may not be used at all for MBMS streaming.

The framework presented in the Internet Draft IETF I-D UXP draft-ietf-avt-uxp-06.txt: “An RTP Payload Format for Erasure-Resilient Transmission of Progressive Multimedia Streams”, October 2003, has the drawback that it destroys the original RTP packet structure by interleaving. It is a requirement of the above cited specification S4-040549, however, to preserve the original RTP packets so that also receiving ends not supporting the FEC are able to obtain the original RTP packets. Moreover, this document is applicable to Reed-Solomon codes only, while there exist more powerful yet less complex FEC codes, like LDPC, Raptor etc. The UXP draft moreover supports as well unequal error protection that may or may not be used at all for MBMS streaming.

The Internet draft IETF I-D draft-luby-avt-rtp-generic-fec-00.txt: “RTP Payload Format for Generic FEC-Encoded Time-Sensitive Media”, Jul. 9, 2004, proposes as well to borrow the packet-based approach of the FLUTE architecture for streaming, for instance by including an FEC Payload Identity (ID) comprising a Source Block Number (SBN) and an Encoding Symbol ID (ESI) in the RTP payload. The SBN identifies a source block to which the RTP packet belongs. The ESI indicates an address or position of the first byte of the RTP packet in the matrix. But the document does not give any details of a packetization, interleaving, source-blocking, encoding and decoding of any particular FEC.

In order to address some of the difficulties mentioned above, matrix-based approaches have been proposed for source-blocking of streaming data for FEC encoding, instead of the packet-based approach. For instance, in the ETSI document EN 301 192 c1.4.1 (2004-06): “Digital Video Broadcasting; DVB Specification for Data Broadcasting”, Reed-Solomon codes are specified to be used for an FEC at the link layer. The matrix-based approach is employed to efficiently deal with variable size IP datagrams in the source-blocking for the FEC.

Such a matrix-based approach is illustrated in FIG. 2, which presents the employed matrix structure. A fixed size matrix comprises N=255 columns and a pre-specified number of rows. Each row comprises one byte per column. The first K=191 columns of the matrix are filled column by column with variable size IP datagrams 23 arranged back-to-back. The last column or columns, which can not be filled with an entire IP datagram anymore, are filled with padding data 25.

An RS (255,191) code is applied across each row of 191 data bytes to produce 64 parity bytes. Thus, each row of the matrix contains a systematic 255-byte long RS codeword 27 comprising 191 data bytes and 64 parity bytes 26. The IP datagrams 23 in the matrix are transmitted independently from each other, along with an additional field that indicates their address in the matrix. The parity bytes 26 are equally transmitted as IP datagrams along with their address in the matrix.

A receiving end can then form a corresponding matrix with whatever IP datagrams it had received by using the address of the datagrams in the matrix. A decoder associated with the receiving end then tries to restore the missing data bytes in the matrix by decoding each RS codeword. The RS decoders that are used for erasure correction are based on structured matrices like Vandermonde matrix or Cauchy matrix. The decoding involves (1) an inversion of a square matrix formed from a subset of the columns of Vandermonde matrix or Cauchy matrix. (2) Multiplication of the received codeword with the inverted matrix. Since each RS codeword is decoded independently, a matrix inversion and multiplication is required for each codeword. This could increase the decoding complexity when compared to the packet-based approach. In the packet-based approach, the positions of the lost bytes are the same in all rows. Thus, only one matrix inversion is needed for decoding all rows of the matrix.

In the technical documents 3GPP S4-040029: “Matrix approach vs. packet approach for MBMS application layer FEC”, Feb. 23-27, 2004, and 3GPP S4-030732: “Outer coding at the BM-SC for IP packet recovery in MBMS”, Nov. 24-28, 2003, it has been proposed to use a similar matrix-based approach employing RS codes at the application layer instead of at the link layer. In this case, the matrix of FIG. 2 would be filled with RTP packets instead of IP datagrams. Similar as the above mentioned document ETSI EN 301 192 c1.4.1, the documents S4-030732 and S4-040029 describe how to apply RS code independently across each row of this matrix.

In the technical document 3GPP S4-040526: “FEC architecture for MBMS Streaming Services”, Aug. 16-20, 2004, it has equally been proposed to use a matrix-based approach to support an FEC for MBMS streaming. It is suggested to include an ESI and an SBN in each RTP packet, and in addition the Source-Block Length (SBL) in each FEC RTP packet. The document describes a generic architecture which allows applying any type of FEC for MBMS streaming. Moreover, after an FEC decoding with the matrix-based approach, the Media RTP packets must be read out from the matrix for consumption, that is, for media decoding or playout. With the current set of fields defined in document S4-040526, it is not possible to recognize the boundaries of the recovered Media RTP packets in the matrix after FEC decoding, though.

In the technical document “3GPP S4-AHP138: FEC packet architecture for MBMS streaming”, Oct. 11-13, 2004, a method ‘for recognizing the boundaries of the recovered Media RTP packets in the matrix after FEC decoding’ is described. This method involves prepending each media RTP packet with its “length field” before arranging it in the matrix for FEC encoding. After FEC encoding, the “length field” is removed and the media RTP packet is transmitted. At the receiver, the received media-RTP packets are prepended with “length field”. The missing media-RTP packets that are recovered by FEC decoding will each have the respective “length field” prepended. The receiver can read the length field and hence recognize the boundaries of the recovered media-RTP packets. However, this architecture recommends a small but fixed symbol size (e.g., 32 bytes) that is advantageous only for certain type of FEC codes which can accommodate large block lengths (e.g., Raptor codes). For the RS codes which have a limitation on block size due to complexity constraints, a more efficient source blocking algorithm that adapts the source blocking parameters to the packet size distribution is desired.

As described above, existing error correction schemes include various disadvantages. As such, there is a need for an efficient algorithm to arrange variable size media RTP packets for FEC encoding and decoding.

### SUMMARY OF THE INVENTION

Embodiment of the invention relate to methods, computer code products and encoders for arranging a plurality of variable size data packets for FEC encoding and decoding. The methods, computer code products, and encoders can include selecting a number of rows of an encoding block arranged in rows and columns, filling the plurality of data packets into the columns of a encoding block, forming FEC data blocks, and appending the filled encoding block with the FEC data blocks. Filling the plurality of data packets into the columns can include if a data packet has a size smaller than the selected number of rows, entering the data packet into a column and padding the remaining rows, or if a data packet has size larger than the selected number of rows, allowing the data packet to span across multiple columns and padding a last column spanned by the data packet.

In one embodiment the number of rows can be selected to equal an average size of the data packets. In another embodiment, the number of rows can be selected based on the following algorithm:

$$For j = 1 to M$$

$$\text{\{} Total\_padding \_j = {\sum }_{k = 1}^{M} ( s\_j ) - [ ( s\_k ) mod ( s\_j ) ]$$

$$If Total\_padding \_j < Min\_Padding , \\ Then Min\_padding = Total\_padding \_j$$

$$Number\_of \_rows = s\_j \text{\}}$$

Where the plurality of data blocks have sizes {s_{—}1,s_{—}2,s_{—}3, . . . ,s_M).

Another embodiment of the invention comprises a system for signaling a hybrid-padding method of encoding data packets. The system can comprise a data packet, including a source block number, a starting column number of the data packet, and a packet length parameter, and an error correction packet, including a source block number, a starting column number of the error correction packet, a number of rows parameter, an N RS-code parameter, and a K RS-code parameter. The system can also include a real-time transmission protocol.

### BRIEF DESCRIPTION OF THE DRAWINGS

FIG. 1 is a diagram illustrating a conventional packet-based FEC encoding.

FIG. 2 is a diagram illustrating a conventional matrix-based FEC encoding.

FIG. 3 is a diagram illustrating a conventional RS-padding approach.

FIG. 4 is a diagram illustrating one embodiment of a hybrid-padding approach according to the present invention.

FIG. 5a is a flow diagram of one embodiment of an encoding method according to the present invention.

FIG. 5b is a flow diagram of one embodiment of a decoding method according to the present invention.

FIG. 6a is a diagram illustrating one embodiment of a formatted data packet according to the present invention.

FIG. 6b is a diagram illustrating one embodiment of a formatted error correction packet according to the present invention.

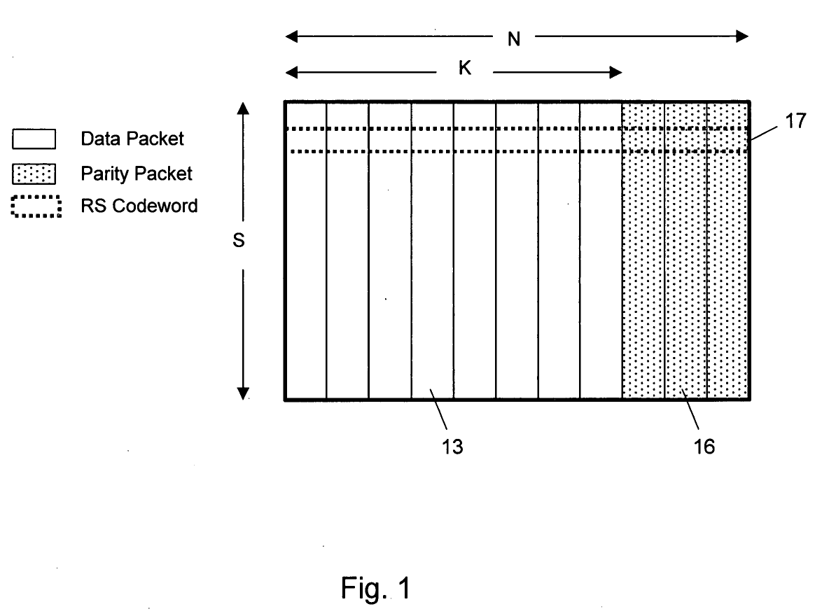

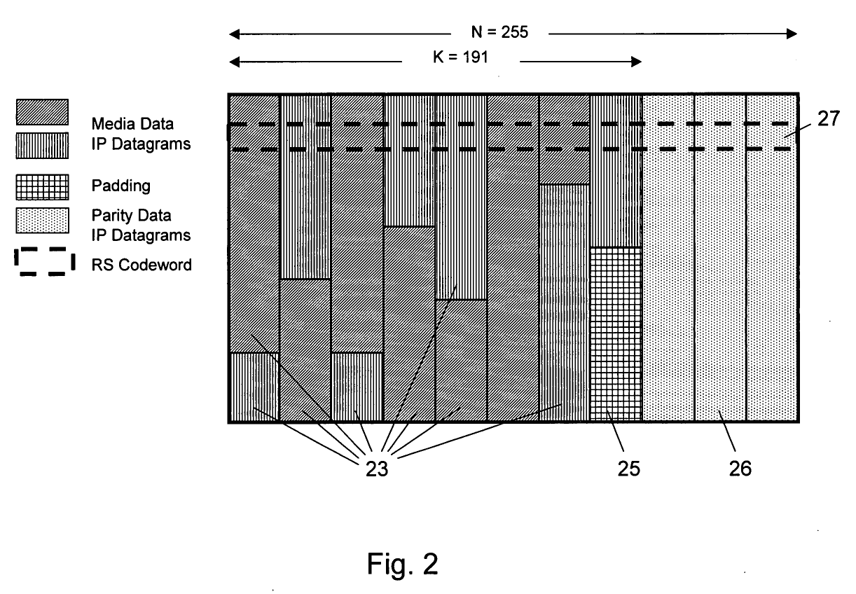

### DETAILED DESCRIPTION OF THE PREFERRED EMBODIMENTS

In embodiments of the subject invention, a hybrid-padding approach for arranging variable size media RTP packets for FEC encoding and decoding may be used. In the conventional RS-padding approach, shorter packets are padded in a source block up to the length of the largest packet in the source block. If the packet size variation is too large, this approach results in a significant amount of padding and correspondingly a large fraction of FEC overhead being used for protecting the padding symbols.

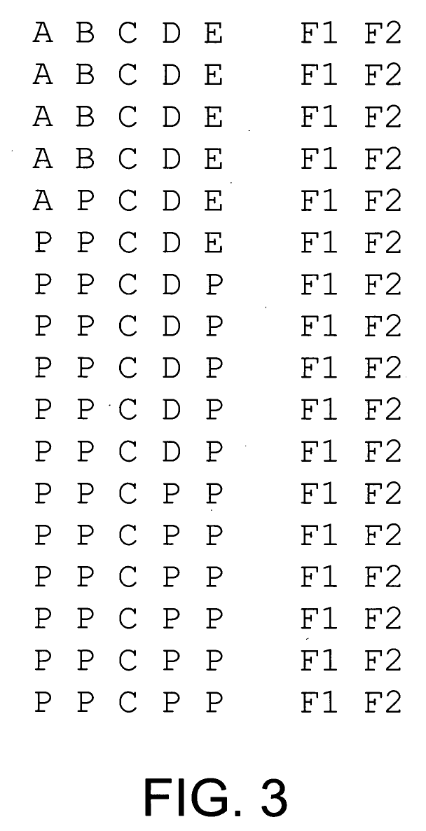

For example, consider the example shown in FIG. 3. Here A, B, C, D, E denote source (media) symbols belonging to consecutive media RTP packets. The packet lengths are 5, 4, 17, 11, and 6 symbols, respectively. The letter “P” denotes a padding symbol. The total number of padding symbols is (17−5)+(17−4)+(17−17)+(17−11)+(17−6)=42. The total number of media symbols is 5+4+17+11+6=43. Thus there are as many padding symbols as the media symbols. For a fixed amount of FEC overhead, this results in
Larger FEC packets and hence less number of FEC packets causing poor error correction performance, and
A large fraction (50%) of the FEC overhead being used to protect padding symbols.

For example, suppose 34 symbols of FEC overhead are used for protecting 43 media symbols. They span into 2 FEC packets. F1 and F2 denote the FEC symbols in the following example.

In one embodiment of the invention, we could bend the largest codeword and make it span across multiple columns, thereby significantly reducing the total amount of padding. The number of rows can be advantageously chosen close to the average packet size in the source block, subject to the constraint that the total number of columns (source & FEC) does not exceed 255. This embodiment of the invention is a hybrid of RS-padding and RS-matrix that does not inherit the complexity of RS-matrix, and that does not need excessive padding.

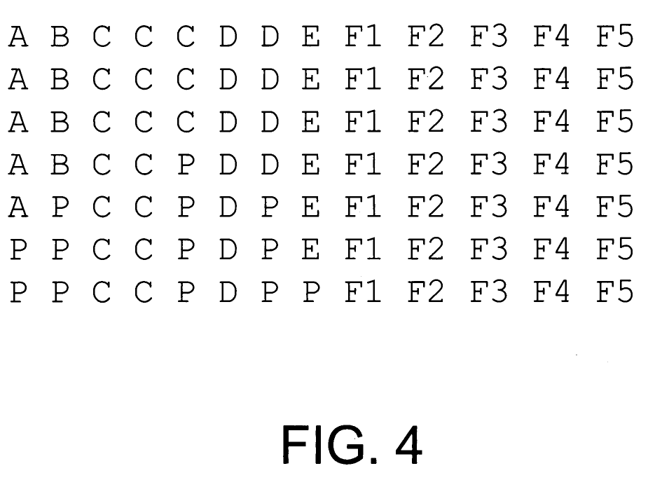

FIG. 4 illustrates this hybrid-padding approach for the above example. A, B, C, D, E denote source symbols. P denotes padding symbols. The total number of padding symbols is 2+3+4+3+1=13. This is only one third of the total number of media symbols in the block. For a fixed amount of FEC overhead, medium size FEC packets and hence more FEC packets, and a small fraction (25%) of FEC overhead are used for protecting padding symbols. If 34 symbols of FEC overhead are used to protect 43 media symbols, then they can span into 5 FEC packets. F1, F2, F3, F4, F5 denote FEC packets in this example. In one embodiment, the padding symbols can be zeros. In other embodiments, the padding symbols can have other values or can be an arbitrary symbol agreed between the sender and receiver.

In one embodiment, the receiver can be provided enough information to form the source/FEC block for FEC decoding. For example, the FEC payload ID can include all necessary information to form the decoding block at the receiver. The source block number could be used to signal the encoding block to which the media/FEC RTP packet belongs. The source sequence number base (the sequence number of the first media-RTP packet in the encoding block) also might be used as an alternative to source block number. The objective is to identify the encoding block to which the RTP packet belongs.

The starting column number of each media-RTP packet in the encoding block can also be signaled so that the receiver can arrange the received RTP packet at the right place in the encoding block. This field could be less than one octet because, for practical purposes, the total number of columns will not exceed 255 for RS codes.

Additional signaling can also be included according to embodiments of the invention for assisting with recognizing the end of that packet. This can be facilitated by the use of the field “PacketLength” in the media-RTP packets. It can be noted that this field is not necessary in FEC-RTP packets because it is not required after the FEC decoding phase.

The “Number of rows” in the encoding block can also be signaled. In addition, because this scheme results in variable N, K values for each encoding block, depending on the packet length distribution, the parameters N and K can be signaled as well. These three parameters can be required for attempting an RS-decoding. Since RS-decoding can be impossible if no FEC-RTP packets are received, it is possible to signal fields “N, K and Number of rows” in FEC-RTP packets only.

Accordingly, in one embodiment the FEC Payload ID of media-RTP packets can have the following three fields:
Source block number
PacketLength
The starting column number

In addition, in this embodiment, the FEC Payload ID of FEC-RTP packets can have the following five fields:
Source block number
N
K
The starting column number
Number of rows

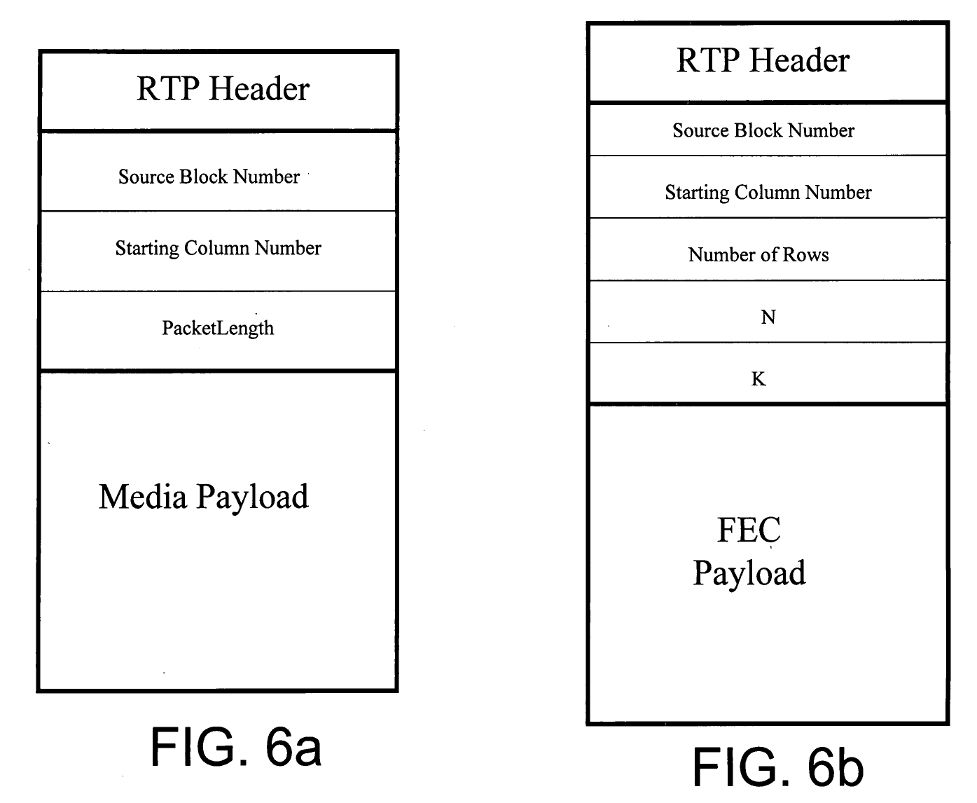

FIGS. 6a and 6b illustrate the formats of media-RTP packet and FEC-RTP packet that contain fields to support hybrid padding in one embodiment of the invention. In another embodiment of the current invention, the field “PacketLength” need not be transmitted at all in the media-RTP packets. A method similar to the one described in “S4-AHP138” could be used to recognize the boundaries of the recovered media-RTP packets in the matrix after FEC decoding.

It should be pointed out that the spirit and scope of this invention is not restricted to MBMS, but it is also applicable to other wireless broadcast technologies (e.g., DVB-H) and also unicast network environment (e.g., Internet, GPRS) and applications (e.g., unicast streaming, video telephony, etc.). Also, while the embodiment decribed herein discussing the RTP protocol, it should be noted that this invention and the signaling or the support of hybrid-padding methods according to the present invention is also applicable to any protocol at any of the ISO OSI layers from 1 to 7.

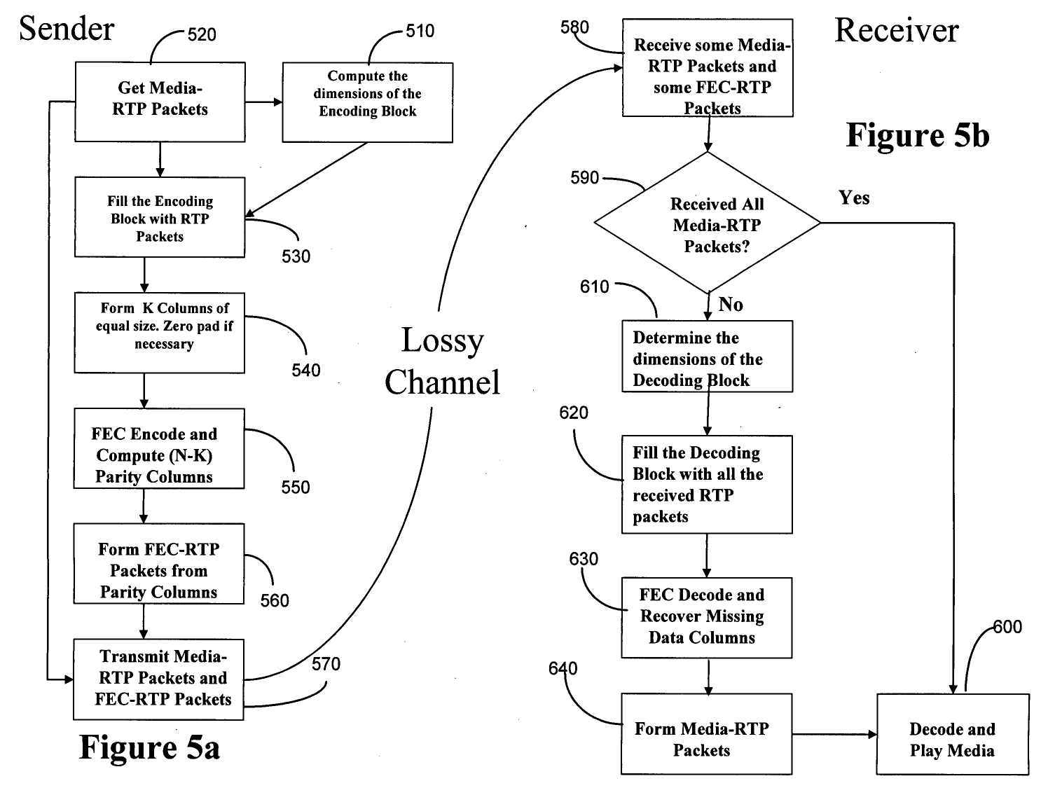

FIG. 5a illustrates one embodiment of a method of hybrid padding encoding according to the present invention. As described above, the encoding block can consist of two parts, the media data and the FEC data. The dimensions of the encoding block can be calculated, in operation 510. The first step in determining the dimensions of the encoding block can include determining the size of the encoding block based on the maximum permissible buffer latency, bearer speed and FEC overhead.

For example, if we consider a 64 kbps bearer is used for MBMS streaming, and assume an FEC overhead of 20% (we define FEC overhead as the additional FEC

data expressed as a percentage of the original media data) and a buffer latency of 5s (i.e., the receiver has to accumulate media and FEC data for 5s before it can decode and play-out the media data) then the total size of the encoding block is 64000*5/8=40 Kbytes.

In this example, the media data block can hold media RTP packets of a total size 32 Kbytes and the FEC data block can hold 8 Kbytes.

Simultaneously, with computing the dimensions of the encoding block we can begin to collect a group of media-RTP packets, operation 520, with a total size approximately equal to the calculated size of the encoding block. We can assume each element in the matrix to be 1 byte in size. Continuing with calculating the dimensions of the encoding block, we can compute the average size of the media-RTP packets in this group. After doing so, in one embodiment of the invention we can set the number of rows in the encoding block equal to the average size of the media-RTP packets in the group.

Alternatively, in another embodiment, the number of rows can be chosen to minimize the padding bytes. In one embodiment, this can be done by collecting a group of media-RTP packets with a total size approximately equal to the media-data block size. For example, let their sizes be {s_{—}1,s_{—}2,s_{—}3, . . . ,s_M) respectively. In this case the following algorithm can be used:
For j=1 to M
{Total_padding_j=(s_j)−[(s_k) mod(s_j)]
If Total_padding_j<Min_Padding,
Then Min_padding=Total_padding_j
Number_of_rows=s_j}

After collecting the group of media-RTP packets, in operation 520, we can being filling the encoding block with the RTP packets in operation 530. In operation 540, the media-RTP packets can be arranged in the columns of the media-data block. If the size of the media-RTP packet is less than the number of rows, the column can be padded until filled. If the size of the media-RTP packet is larger than the number of rows, then this packet may span across multiple columns and the last column spanned by this packet can be padded until filled.

In one embodiment of the invention each media-RTP packet is started in a new column. The size of FEC columns can equal the size of media columns. For a fixed FEC overhead, the FEC data block size can be computed as explained above. The number of FEC columns can equal the size of FEC data block divided by the number of rows. The total number of columns can equal the sum of the number of data columns and number of FEC columns. If the total number of columns>255, we can increase the number of rows by 1 and go to back to arranging the RTP packets in the columns of the media-data block. Otherwise, if the total number of columns<255, we can set K=number of data columns and N=total number of columns.

Next, in operation 550, the elements of the FEC data block can be formed by generating (N-K) parity symbols from each row of K symbols taken from the media data matrix. A systematic (N, K) RS code can be used to generate these parity symbols. This process can be repeated for all rows in order to fill the FEC data matrix.

In operation 560, the media-RTP packets can be modified to form FEC-RTP packets. This can be done by appending each of the media-RTP packets in the encoding block to a FEC Payload ID. Each FEC column generated in this manner can be appended with an appropriate RTP header and FEC payload ID. The FEC payload ID can include all necessary information to form the decoding block at the receiver. For example, the FEC Payload ID of media-RTP packets can have the following three fields:
Source block number,
PacketLength
The starting column number

The FEC Payload ID of FEC-RTP packets can have the following five fields:
Source block number,
N
K
The starting column number
Number of rows

Finally, in operation 570, the Media-RTP packets and FEC-RTP packets can be transmitted.

FIG. 5b illustrates one embodiment of hybrid-padding decoding according to the present invention. In this embodiment FEC decoding may be possible only if at least one FEC-RTP packet belonging to an encoding block is received. After receiving any one of the FEC-RTP packets of a block, in operation 580, the receiver/decoder can determine, in operation 590, if all of the media-RTP packets have been received. If so, the receiver/decoder can decode and play the media in operation 600.

If not all of the media-RTP packets are successfully received by the receiver, the receiver/decoder can attempt to recover the missing information. After receiving one of the FEC-RTP packets of a block, the receiver/decoder can determine N and K of the RS code as well as the number of rows of the decoding block. Thus, it can calculate the dimensions of the decoding block, in operation 610. The receiver/decoder can than fill the decoding block, in operation 620, by arranging the media-RTP packets and FEC-RTP packets according to the field “starting column number.” If at least K columns out of total N columns of the decoding block are filled, then decoding will be successful.

If decoding is not successful, the receiver/decoder can attempt to recover the missing information in operation 630. Based on the positions of K received columns, the receiver/decoder can form the square sub-matrix of Vandermonde or Cauchy matrix. The receiver/decoder can invert the square sub-matrix once and multiply it with the set of received packets to recover the columns of the media-data block.

Next, in operation 640, the receiver/decoder can form the Media-RTP packets. This can be done by using the “PacketLength” field of the media-RTP packets to read out the media-RTP packets from the media-data columns for play-out.

While several embodiment have been shown and described herein, it should be understood that changes and modification can be made to the invention without departing from the invention in its broader aspects. Various features of the invention are defined in the following claims.

What is claimed is:

1. A method for arranging a plurality of variable size data packets for FEC encoding and decoding, the method comprising:
Selecting a number of rows of an encoding block arranged in rows and columns;
Filling the plurality of data packets into the columns of a encoding block by:
if a data packet has a size smaller than the selected number of rows, entering the data packet into a column and padding the remaining rows with at least one padded symbol; or
if a data packet has size larger than the selected number of rows, allowing the data packet to span across multiple columns and padding a last column spanned by the data packet with at least one padded symbol;
Forming FEC data blocks; and
Appending the filled encoding block with the FEC data blocks.

2. The method of claim 1, wherein the number of rows is selected to equal an average size of the data packets.

3. The method of claim 1, wherein the number of rows is selected based on the following algorithm:
$$For j = 1 to M$$
$$\text{\{} Total\_padding \_j = {\sum }_{k = 1}^{M} ( s\_j ) - [ ( s\_k ) mod ( s\_j ) ]$$
$$If Total\_padding \_j < Min\_Padding , \\ Then Min\_padding = Total\_padding \_j \\ Number\_of \_rows = s\_j \text{\}}$$
$$Where the plurality of data blocks have sizes \{ s\_ 1 , s\_ 2 , s\_ 3 … , s\_M ) .$$

4. The method of claim 1, wherein, the at least one padded symbol is zero.

5. The method of claim 1, wherein the at least one padded symbol is an arbitrary symbol that is agreed between a sender and receiver.

6. A computer code product for arranging a plurality of variable size data packets for FEC encoding and decoding, the computer code product comprising computer code configured to:
Select a number of rows of an encoding block arranged in rows and columns;
Fill the plurality of data packets into the columns of a encoding block by:
if a data packet has a size smaller than the selected number of rows, entering the data packet into a column and padding the remaining rows with at least one padding symbol; or
if a data packet has size larger than the selected number of rows, allowing the data packet to span across multiple columns and -padding a last column spanned by the data packet with at least one padding symbol;
Append the filled encoding block with the FEC data blocks.

7. The computer code product of claim 6, wherein the number of rows is selected to equal an average size of the data packets.

8. The computer code product of claim 6, wherein the number of rows is selected based on the following algorithm:
$$For j = 1 to M$$
$$\text{\{} Total\_padding \_j = {\sum }_{k = 1}^{M} ( s\_j ) - [ ( s\_k ) mod ( s\_j ) ]$$
$$If Total\_padding \_j < Min\_Padding , \\ Then Min\_padding = Total\_padding \_j \\ Number\_of \_rows = s\_j \text{\}}$$
$$Where the plurality of data blocks have sizes \{ s\_ 1 , s\_ 2 , s\_ 3 … , s\_M ) .$$

9. The computer code product of claim 6, wherein the at least one padded symbol is zero.

10. The computer code product of claim 6, wherein the at least one padded symbol is an arbitrary symbol that is agreed between a sender and receiver.

11. An encoder configured for encoding a plurality of variable size data packets for FEC, the encoder comprising:
A processor;
Memory;
Wherein the processor is configured to Select a number of rows of an encoding block arranged in rows and columns;
Fill the plurality of data packets into the columns of a encoding block by:
if a data packet has a size smaller than the selected number of rows, entering the data packet into a column and padding the remaining rows with at least one padding symbol; or
if a data packet has size larger than the selected number of rows, allowing the data packet to span across multiple columns and padding a last column spanned by the data packet with at least one padding symbol;
Form FEC data blocks; and
Append the filled encoding block with the FEC data blocks.

12. The encoder of claim 11, wherein the number of rows is selected to equal an average size of the data packets.

13. The encoder of claim 11, wherein the number of rows is selected based on the following algorithm:
$$For j = 1 to M$$
$$\text{\{} Total\_padding \_j = {\sum }_{k = 1}^{M} ( s\_j ) - [ ( s\_k ) mod ( s\_j ) ]$$
$$If Total\_padding \_j < Min\_Padding , \\ Then Min\_padding = Total\_padding \_j \\ Number\_of \_rows = s\_j \text{\}}$$
$$Where the plurality of data blocks have sizes \{ s\_ 1 , s\_ 2 , s\_ 3 … , s\_M ) .$$

14. The encoder of claim 11, wherein the at least one padding symbol is zero.

15. The encoder of claim 11, wherein the at least one padding symbol is an arbitrary symbol that is agreed between a sender and receiver.

16. A system for signaling a hybrid-padding method of encoding data packets, the system comprising:
A data packet including:
A source block number; and
A starting column number of the data packet; and
An error correction packet including:
A source block number;
A starting column number of the error correction packet;
A number of rows parameter;
An N RS-code parameter; and
A K RS-code parameter.

17. The system of claim 16, further comprising a real-time transmission protocol.

18. The system of claim 16, further comprising an optional packet length parameter which is used in an FEC encoding and decoding procedure but not signaled.

19. The system of claim 16, further comprising a real-time transmission protocol.
